(19) United States
(12) Patent Application Publication
(10) Pub. No.: US 2013/0136864 A1
(43) Pub. Date: May 30, 2013

(54) PASSIVE TERMPERATURE CONTROL OF HPC ROTOR COATING

(71) Applicants: Christopher W. Strock, Kennebunk, ME (US); Charles R. Beaudoin, Lyman, ME (US); Robert D. Richard, Springvale, ME (US)

(72) Inventors: Christopher W. Strock, Kennebunk, ME (US); Charles R. Beaudoin, Lyman, ME (US); Robert D. Richard, Springvale, ME (US)

(73) Assignee: UNITED TECHNOLOGIES CORPORATION, Hartford, CT (US)

(21) Appl. No.: 13/304,809

(22) Filed: Nov. 28, 2011

(51) Int. Cl. B05D 1/32; B05D 7/00; B05C 11/00; B05D 1/02; B05C 13/00; B05C 5/00

(52) U.S. Cl. 427/282; 118/500

(57) ABSTRACT

A method and fixture for holding a part being spray coated at an elevated temperature by placing the part between a base forming an insulating cover and an upper insulation board. The space therebetween forms an area for positioning a part to be sprayed. The cover and board are sized to retain heat in the part at a steady predetermined temperature when the part is spray coated. The part is heated for sufficient time to uniformly bring the part to temperature, followed by applying a spray to coat the part.

### BACKGROUND

High pressure compressor (HPC) rotors are processed by coating with aluminum oxide in a spray process in which the particles are heated to approximately their melting point and the parts are heated to about 800° F. (427° C.). With the particles heated to their melting point or just superheated, the substrate temperature control is critical to achieving the desired level of bonding between particles in the coating.

If the part is too hot, the coating will be too dense, hardness and modulus too high, and it will not machine correctly or have the required strain tolerance for service. If the part is too cool, bonding will be poor, resulting in a low durability, soft coating.

A prior art method for controlling temperature of the part is to operate a secondary heat source that is controlled either in an open loop mode or in a closed loop mode based upon thermocouple or pyrometer feedback. This method therefore needs constant monitoring and potentially constant adjusting of the secondary heat source.

It would be an advantage to provide a method and a fixture design that would reduce or eliminate the need for temperature feedback. Elimination of a secondary heat source would also simplify the method.

### SUMMARY

The present invention is an improved method and a fixture design that facilitates use of the method. Heat from a spray torch is used to preheat the part after the part is mounted in a masking fixture. The masking fixture has a low thermal mass for rapid heating and a predetermined amount of integral insulation. The insulation serves to achieve a balance of heat loss to the environment compared to heat input from the spray process at the desired operating temperature. The temperature of the part remains constant.

During the preheat time, the spray torch, with no powder feeding, is held closer to the rotating part than it is during coating. This maximizes the heating rate. At a particular point in time, the surface of the part exceeds the target temperature for coating. After a predetermined time, the torch is moved away to the correct distance for the coating process. For some additional time, powder is not fed to the torch and the part surface temperature drops to approach the target process temperature. Once within a tolerance of the target temperature, powder is fed to the torch and the coating process is started with no further change in the heat input rate or part temperature. Thus the heat input rate control remains constant so the temperature of the part remains constant. As a result, coating quality is optimized.

### BRIEF DESCRIPTION OF THE DRAWINGS

FIG. 1 a flow diagram of the method of this invention.

FIG. 2 is a perspective view of the device used in the method of this invention, shown without the conventional spray torch that serves as a source of heat.

FIG. 3 is a section view of the device of FIG. 2.

FIG. 4 is an enlarged view of the bottom right portion of the device of FIG. 3.

FIG. 5 is a graph showing the normalized part temperature as a function of time.

### DETAILED DESCRIPTION

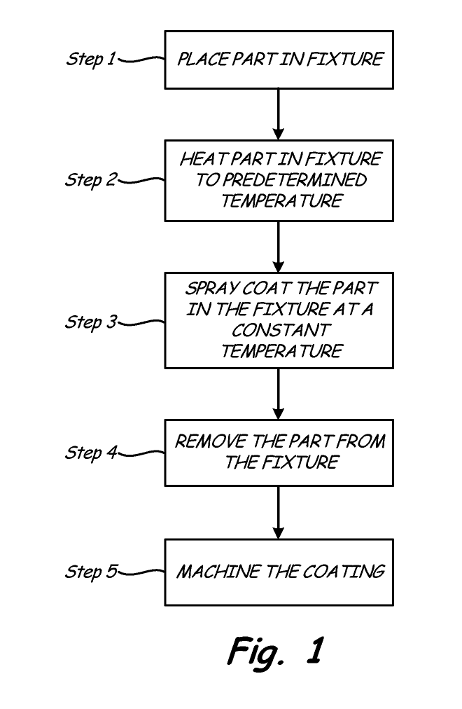

FIG. 1 illustrates the method used to spray coat gas turbine parts such as rotors. Step 1 comprises placing the part to be spray coated in a device. The device, described below, has insulation, space for convection heat flow, and access to the part for the spray to contact and coat the part. A test strip can also be mounted on the fixture for quality control.

Step 2 comprises heating the part and fixture. The spray torch that will be used to coat the part can be used to provide the necessary heat, although other sources of heat can be used. What is needed is to heat the part and fixture so that even the interior of the part and the components of the fixture are at a predetermined temperature that has been determined experimentally to be that temperature at which the conductive, radiative, and convection heat flows cause the part and fixture to reach a steady state temperature during the next step. A typical steady state temperature is 800° F. (427° C.).

Step 3 comprises spray coating the part, such as with aluminum oxide as desired. The spray torch may be positioned slightly further from the location used to heat the part and fixture, if necessary. The spray torch melts or greatly softens the coating particles and deposits them on the part. It is important to achieve the desired level of bonding between the particles in the coating on the part. If the part is too hot, the coating will be too dense, too hard, and have too high a modulus, so that it will not machine correctly. It will also not have the required strain tolerance for service. If the part is too cool, bonding will be poor, resulting in a low durability soft coating. Additionally, the part temperature during spray influences the residual stress contribution from thermal expansion coefficient mismatch between the coating and substrate.

One factor in spray coating of parts is that the spray broadens or fans after leaving the spray torch nozzle. If the spray direction is parallel to the line of sight to the part along a masking surface, half or more will end up going up and away from the masking surface and result in decreased coating thickness on the part adjacent to the masking. To remedy this, the spray is angled toward the masking to approach the part at an angle, thus coating the entire region to be sprayed.

Step 4 simply comprises removing the part after it cools and the coating has bonded properly. The coating on the part is machined, Step 5, in some cases using a single point turning on a lathe with a diamond cutting tool. The part is now ready for use with good results.

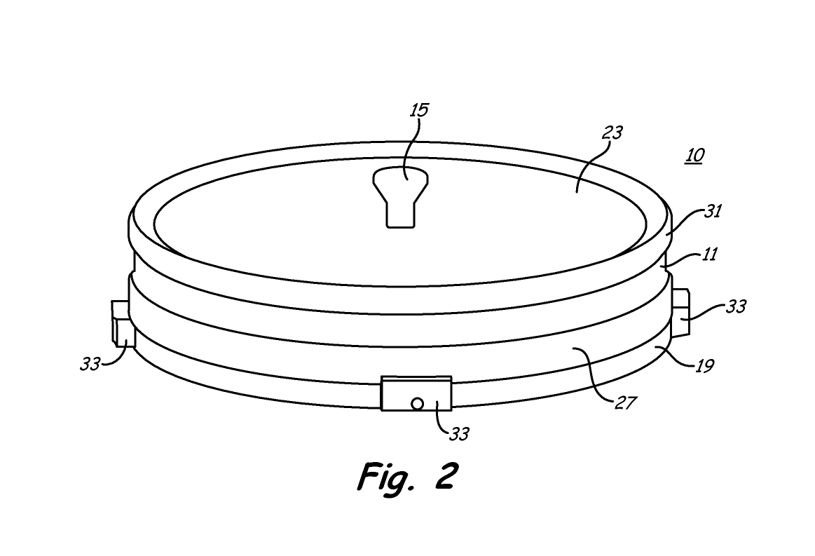

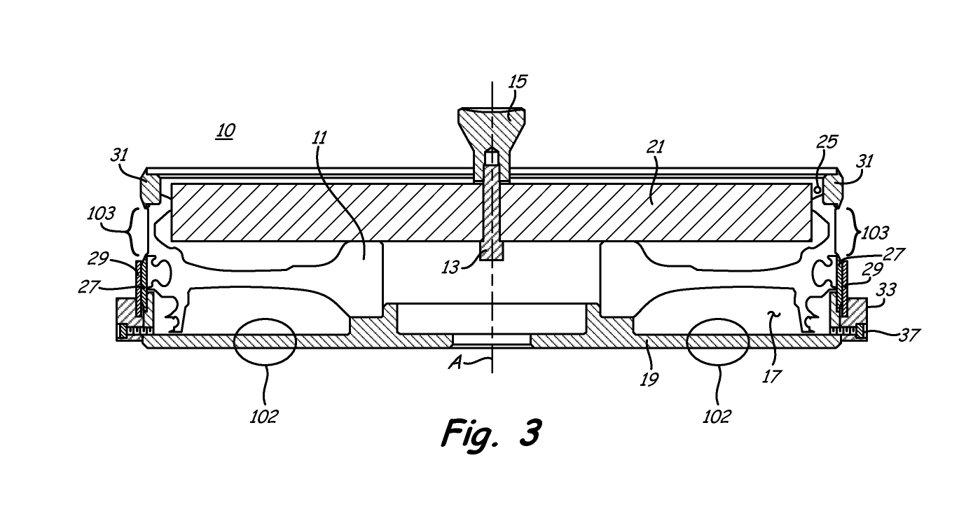

FIG. 2 shows the fixture device 10 of this invention in perspective. Fixture 10 is intended to be used in processes such as described above. The spray coating process is conventional but the temperature control is new, as described above. What is new is that fixture 10 is designed to retain the correct amount of heat during the coating process so that the part remains at a constant temperature to ensure optimization of the coating on the part. Fixture 10 is made from any solid material such as metal. In one embodiment fixture 10 is made from a 17-4 PH stainless steel alloy. Fixture 10 may be annular in shape, as shown in FIGS. 2 and 3, and has an axis of rotation A in FIG. 3.

The part 11, shown in FIG. 3 as a turbine rotor disk, is held in place on fixture base 19 by gravity and location on an annular snap diameter feature 20. Insulating cover 21 is fastened by bolt 13 to lifter knob 15 for ease of handling. Part 11, which will be coated on its circumference as described below, is designed to interface with a cantilevered vane (not shown) that is fixed at its OD and part 11 functions as a shroud for ID of the vane, and thus the circumference of part 11 is to be spray coated. Part 11 is located in an area 17 between fixture base 19 and insulation cover 21. Insulating cover 21 is made from any high temperature insulation materials such as those used in furnaces and kilns. Examples are fiber and foam structures of alumina, aluminosilicates or zirconia. Alumina fiber board has been used successfully. Fixture base 19 is made of a thermally stable metal, in one case 17-4 PH stainless steel. The metallic construction provides durable, close tolerance support for part 11 and lower mask 27 while providing features that help to thermally isolate the part. Fixture base plate 19 is thinned in region 102 to limit heat capacity and conduction from the perimeter of part 11 where the coating process provides heat input over area 104. Coating is applied to area 103 on part 11, the test sample 29 plus approximately 0.5 inches (1.27 cm) to either side to allow for passage of the entire spray plume 30 and uniform coating coverage.

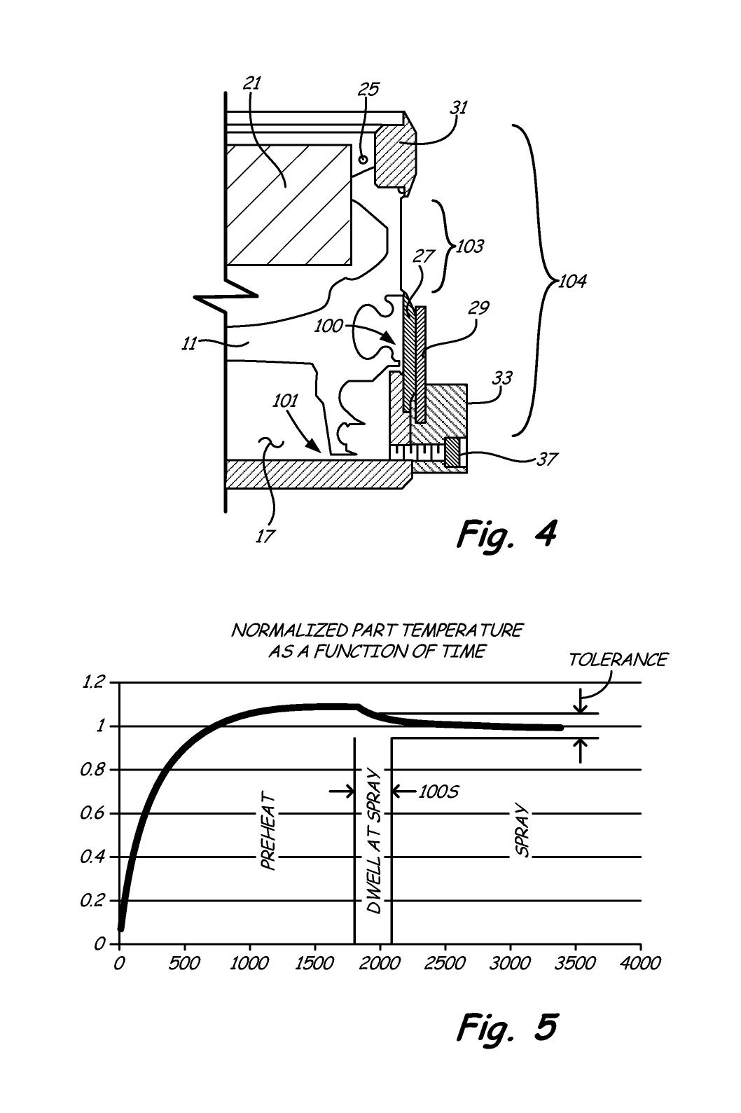

Insulation board 21 is protected from the spray process by top mask 31 with space 25 between board 21 and mask 23, best seen in FIG. 4, to permit air or other gasses to circulate, thus creating a convection path sized to control the amount of heat loss by mask 31. Space 17 also provides a place for air or other gasses to function to define heat convection paths, depending on the shape of part 11. If required, space 17 may be filled with insulating material or may be filled with conductive material as required to reduce or increase the rate of heat loss from the coated area as required to establish desired equilibrium temperature during the spray process. Mask 31 also prevents the part from becoming coated in areas where coating is not required.

FIGS. 3 and 4 also shows annular lower mask 27, holder 33 that holds test panel 29 in place and annular upper mask 31. Fixture base 19 locates part 11, mask 27 and test piece holder 33. In turn, upper mask 31 and insulating cover 21 are located from part 11. Test panel holder 33 is fastened to the side 35 of fixture 10 with bolts 37. Test panel 29 is used for quality control of the coating but is not a component of part 11.

FIG. 5 illustrates the achievement of a steady state part temperature using the method and device of this invention. FIG. 5 shows the part temperature, normalized to a scale of 0 to 1 rather in actual degrees, as a function of time. The first section of FIG. 4 up to about 1800 seconds uses a higher heat input parameter to help get the part up to temperature rapidly and also to soak heat into the center of the part. Parameters are then changed to those for coating, over a short duration such as about 100 seconds so the part temperature in the coating area (on the circumference of part 11) drops back down to within a chosen tolerance around the target. This drop in temperature is due to conduction to the part core as well as the more rapid heat loss to the environment that occurs at the higher temperature achieved during preheat.

The rate of heat loss by radiation for a heated surface is an exponential function in temperature, so that a small change in temperature results in a much larger change in the radiated power. Planck's Law shows I/(v,T)=2hv³/c²×l/e^{hv/kT}−1, where I(v,T is the energy per unit of time or power radiated per unit area of emitting surface in the normal direction per unit solid angle per unit frequency by a black body at temperature T. In the equation, h is the Plank constant, c is the speed of light, k is the Boltzman constant, v is the frequency of the electromagnetic radiation, and T is the temperature of the body in degrees Kelvin.

A second method of heat loss to the environment is by convective loss to the air. This rate is directly proportional to the difference in temperature between the part and air. dQ/dt=Q=h·A(Tₑₙᵥ−T(t)=−h·AΔT(t). In this equation, Q is the thermal energy in joules, h is the heat transfer coefficient (assumed independent of T here), A is the surface area of the heat being transferred, T is the temperature of the object's surface and interior, Tₑₙᵥ is the temperature of the environment (the temperature far from the surface) and Δ T(t)=T(t)−Tₑₙᵥ.

The third method of heat loss is by conduction to cooler regions of the part and fixturing. This is minimized by allowing the part to “soak” or allow time for heat to be conducted into the part center or hub, and by minimizing contact with the supports that hold this part and fixture to the turntable in the spray booth.

As can be seen from FIG. 5, spray deposition of a part is conducted at a temperature within the chosen tolerance and no adjustment of the operating conditions of the spraying process is needed or attempted after the required time has lapsed. In FIG. 5, this occurs at about 2,250 seconds. The size of the insulation, the radiation, the paths of convection and conduction are balanced so that during the spray process, the heat input from the spray to the part is equal to the heat lost by convection, radiation and conduction. The balance may be determined experimentally. By eliminating feedback requirements and any need to change the heating or cooling of the part, substantial savings and efficiencies are achieved by the present invention. Proper coatings, as achieved by the present invention, provide coatings that have longer life as well.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fixture for holding a part being spray coated at an elevated temperature, the fixture comprising:
a base forming an insulating cover;
an upper insulation board spaced from the base, the space there between forming an area for positioning a part to be sprayed;
a lower mask for shielding a portion of the part from the spray coating;
an upper mask for further shielding a portion of the part from the spray coating; and
the insulating cover and upper insulation board being sized to permit heat loss to the environment at a rate equal to the rate of heat input from the process.

2. The fixture of claim 1, wherein the base is adapted to position a test panel radially out from the lower mask adjacent to the part exposed to the spray coating.

3. The fixture of claim 1, wherein the fixture is annular and has an axis of rotation.

4. The fixture of claim 1, wherein the part is a gas turbine engine part.

5. The fixture of claim 6, wherein the part is an integrally bladed rotor.

6. A method holding a part at an elevated temperature while it is being spray coated, the method comprising:
placing a part between a base forming an insulating cover and an upper insulation board spaced from the base, the space therebetween forming an area for positioning the part to be sprayed;
mounting a part relative to the upper insulation member using an upper mask; the insulating cover and upper insulation board being sized to retain heat in the part at a predetermined temperature when the part is spray coated with a process that provides a predetermined heat input rate.

7. The method of claim 6, wherein the lower mask is adapted to position a test panel radially out from the part positioning area.

8. The method of claim 6, wherein the device is annular and has an axis of rotation.

9. The method of claim 6, the part is a gas turbine engine part.

10. A method of spray coating a part at an elevated temperature, the method comprising:
placing the part between a base forming an insulating cover and an upper insulation board spaced from the base, the space therebetween forming an area for positioning the part to be sprayed, the insulating cover and upper insulation board being sized to retain heat in the part at a predetermined temperature when the part is spray coated at a predetermined heat input rate;
mounting the part relative to the upper insulation member using an upper mask;
heating the part for sufficient time to uniformly bring the part to a predetermined temperature; and
applying a quantity of spray to coat the part.

11. The method of claim 10, wherein the base is adapted to position a test panel radially out from the part positioning area.

12. The method of claim 10, wherein the device is annular and has an axis of rotation.

13. The method of claim 10, wherein the part is a gas turbine engine part.

14. The method of claim 13, wherein a spray torch used to spray coat the part is used for heating the part to bring the part to the predetermined temperature.
